(19) United States
(12) Patent Application Publication
(10) Pub. No.: US 2013/0007327 A1
(43) Pub. Date: Jan. 3, 2013

(54) USING POWER DIVIDING MATCHING NODES TO OPTIMIZE INTERCONNECTS

(76) Inventor: Victor Prokofiev, Phoenix, AZ (US)

(21) Appl. No.: 13/173,959

(22) Filed: Jun. 30, 2011

(51) Int. Cl. G06F 13/00

(52) U.S. Cl. 710/300

(57) ABSTRACT

Systems and methods of improving computing system interconnects may involve providing an upstream channel and a plurality of downstream channels. A passive matching node can be connected to the upstream channel and the downstream channels, wherein the matching node is configured to couple power between the upstream memory channel and the downstream channels. The matching node may also perform impedance matching as well as isolate two or more signals on the downstream channels from one another. In one example, the matching node includes a power divider/combiner.

### BACKGROUND

1. Technical Field

Embodiments generally relate to computing system interconnect architectures and memory devices. More particularly, embodiments relate to the use of microwave dividers/combiners to optimize computing system interconnects.

2. Discussion

In computing systems, conventional memory bus designs may include architectures that interconnect memory modules to one another via either a daisy chain topology (e.g., one or multiple modules) or a “T” topology (e.g., two modules). Both solutions can have significant discontinuities between each memory module, as well as a common transmission line connected to a central processing unit (CPU) or chipset. Accordingly, interconnect design optimization for such memory bus architectures may be time consuming and expensive. Moreover, adding or removing modules to the computing system can have a negative impact on interconnect performance, and could require system redesign.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a circuit board having memory connectors according to an embodiment;

FIG. 2 is a block diagram of an example of a circuit board having directly mounted memory devices according to an embodiment;

FIG. 3 is a block diagram of an example of a memory card according to an embodiment;

FIG. 4 is a block diagram of an example of a connector according to an embodiment; and

FIG. 5 is a flowchart of an example of a method of fabricating a memory bus according to an embodiment.

### DETAILED DESCRIPTION

Embodiments may include a circuit board having a substrate with an upstream channel and a plurality of downstream channels. The circuit board may also have a matching node to couple power between the upstream channel and the plurality of downstream channels. In one example, the matching node isolates two or more signals on the plurality of downstream channels from one another. As will be discussed in greater detail, the matching node could include a power divider/combiner, a microwave coupler, a transformer based device, and so on.

Embodiments may also include a connector having a housing with an upstream channel and a plurality of downstream channels. In addition, the connector can have a matching node to couple power between the upstream channel and the plurality of downstream channels. In one example, the matching node isolates two or more signals on the plurality of downstream channels from one another.

Other embodiments may involve a method of fabricating a memory bus in which an upstream memory channel and a plurality of downstream memory channels are provided. The upstream memory channel and the plurality of downstream memory channels can include at least one of an address line, a data line and a control line. The method may also involve connecting a matching node to the upstream memory channel and the plurality of downstream memory channels, wherein the matching node is to couple power between the upstream memory channel and the plurality of downstream memory channels. The matching node may also match an impedance of the upstream channel to one or more impedances of the plurality of downstream channels. Moreover, coupling the power between the upstream channel and the plurality of downstream channels can involve isolating two or more signals on the plurality of downstream channels from one another.

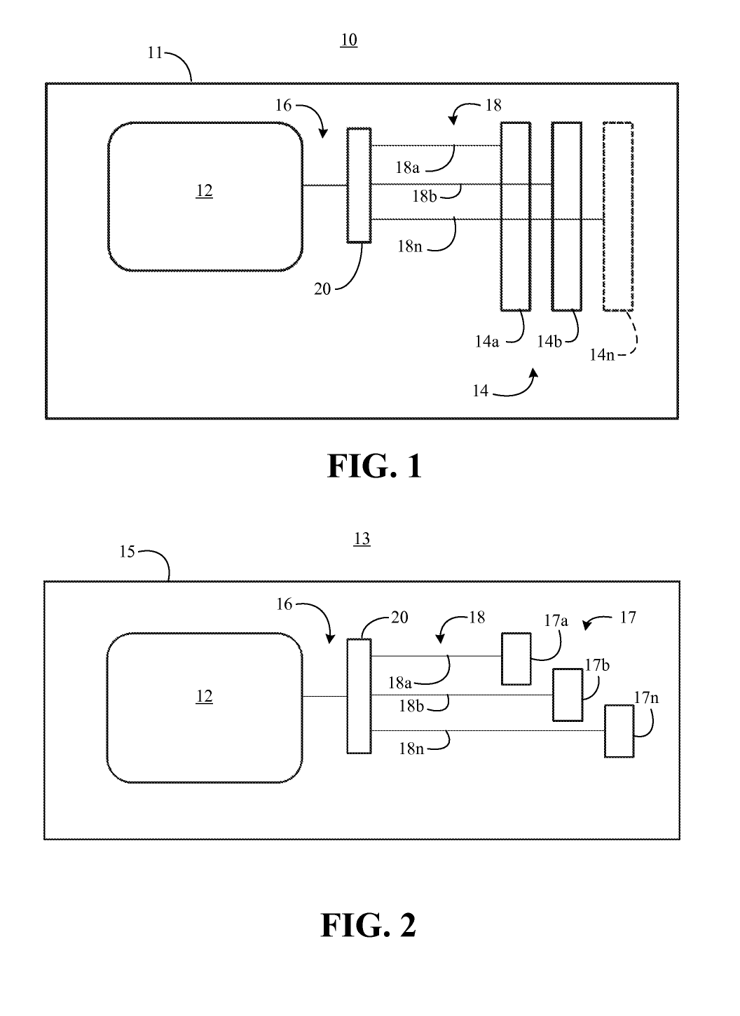

Turning now to FIG. 1, a circuit board 10 is shown. The circuit board 10 could be associated with a computing system such as a server, desktop personal computer (PC), laptop computer, smart tablet, wireless smart phone, mobile Internet device (MID), personal digital assistant (PDA), etc. In the illustrated example, the circuit board 10 includes a substrate 11 coupled to a processor (e.g., having one or more cores, integrated memory controllers, etc.) 12 and a plurality of memory connectors 14 (14a-14n), which may in turn be connected to system memory such as dynamic random access memory (DRAM) configured as memory modules. The memory modules might include dual inline memory modules (DIMMs), small outline DIMMs (SODIMMs), etc. The illustrated processor 12 is coupled to an upstream channel 16, whereas the connectors 14 may be coupled to a corresponding plurality of downstream channels 18 (18a-18n). Thus, the upstream channel 16 and downstream channels 18 could include data lines, address lines, control (e.g., status, strobe) lines, etc., that enable communications between the processor 12 and memory modules.

The circuit board 10 may also include a matching node 20 that is coupled to the upstream channel 16 as well as the downstream channels 18. In particular, the matching node 20 can be a passive device that is configured to couple power between the upstream channel 16 and the downstream channels 18, isolate signals on the downstream channels 18 from one another, and match the impedance of the upstream channel 16 to one or more impedances of the downstream channels 18. The matching node 20 could therefore include a power divider/combiner (e.g., Wilkinson power divider/combiner), microwave coupler (e.g., built on transmission lines or waveguides), transformer based device (e.g., high frequency), or any other suitable device able to achieve one or more of the coupling, matching and isolation functionality described herein.

The matching node 20 may therefore improve bus performance, reduce interconnect length sensitivity, and make design processes more effective. For example, matching impedances and isolating signals can eliminate reflections across signals on the downstream channels 18, and may significantly decrease inter-symbol interference (ISI). Thus, a signal from a memory module on one or more of the downstream channels such as downstream channel 18a would not be reflected back onto another downstream channel such as downstream channel 18b, in the example shown. The reduction in ISI can lead to a corresponding reduction in bit error rate (BER) as well as an increase in the maximum data rate and overall system performance. Moreover, the illustrated approach provides more flexibility with respect to the length of the channels 16, 18, which can accelerate and enhance the system design process.

The processor 12 could alternatively be a chipset component such as a platform controller hub (PCH), input/output controller hub (ICH), etc. Additionally, the channels 16, 18 could be non-memory channels. For example, the connectors 14 might be coupled to system components other than memory, such as peripheral devices, network controllers, user interface (UI) components, and so on. Indeed, the circuit board 10 could also include network controllers, solid state drive (SSD) NAND chips, basic input/output system (BIOS) memory, and so on (not shown). In the case of a network controller, the channels 16, 18 could provide off-platform 10 communication functionality for a wide variety of purposes such as cellular telephone (e.g., W-CDMA (UMTS), CDMA2000 (IS-856/IS-2000), etc.), WiFi (e.g., IEEE 802.11, 1999 Edition, LAN/MAN Wireless LANS), Bluetooth (e.g., IEEE 802.15.1-2005, Wireless Personal Area Networks), WiMax (e.g., IEEE 802.16-2004, LAN/MAN Broadband Wireless LANS), Global Positioning System (GPS), spread spectrum (e.g., 900 MHz), RS-232 (Electronic Industries Alliance/EIA), Ethernet (e.g., IEEE 802.3-2005, LAN/MAN CSMA/CD Access Method), power line communication (e.g., X10, IEEE P1675), USB (e.g., Universal Serial Bus 2.0 Specification), digital subscriber line (DSL), cable modem, T1 connection, etc.

FIG. 2 shows an alternative approach in which a circuit board 13 includes a substrate 15 coupled to a processor 12 and/or other chipset component and a plurality of memory devices 17 (17a-17n), which may include system memory/memory module, as already discussed. Thus, the memory devices 17 are directly attached (e.g., by solder reflow or other method) to the substrate 15, in the example shown. The illustrated processor 12 is coupled to an upstream channel 16, whereas the memory devices 17 may be coupled to a corresponding plurality of downstream channels 18. Moreover, a matching node 20 can be coupled to the upstream channel 16 as well as the downstream channels 18 in order to couple power between the upstream channel 16 and the downstream channels 18, and to match the impedance of the upstream channel 16 to one or more impedances of the downstream channels 18, as already discussed.

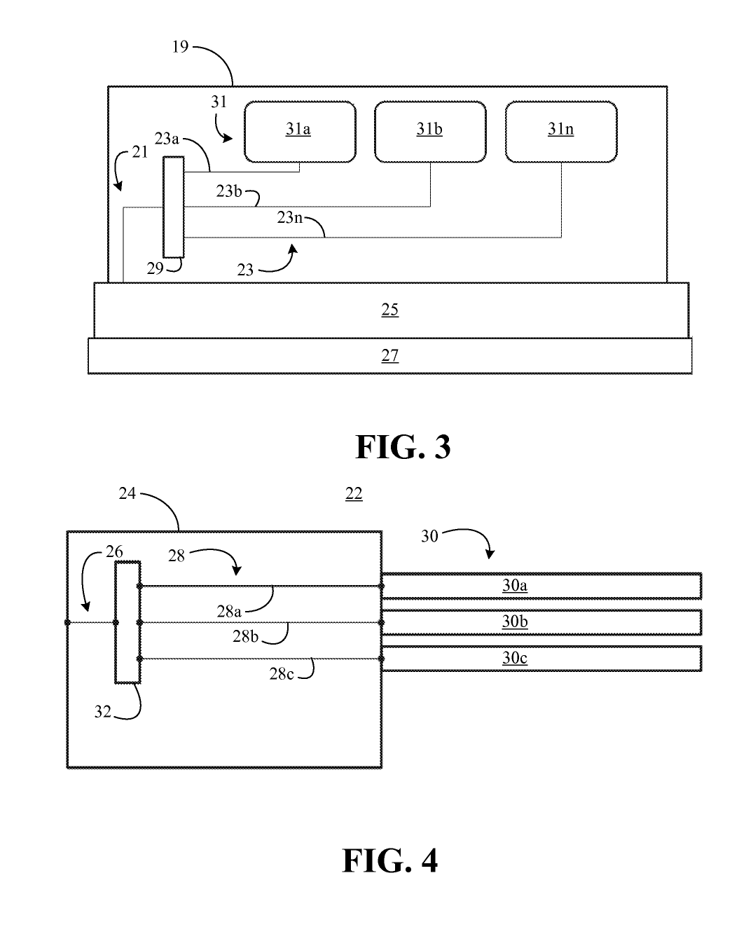

Turning now to FIG. 3, still another approach is shown in which a memory card 19 has a substrate with an upstream channel 21 and a plurality of downstream channels 23 (23a-23n). The memory card 19, which may be plugged into a connector 25 that is mounted to a circuit board 27, can also have a matching node 29 that couples power between the upstream channel 21 and the plurality of downstream channels 23. In the illustrated example, a plurality of memory chips 31 (31a-31n) includes a memory chip coupled to each of the plurality of downstream channels 23.

FIG. 4 shows another alternative approach in which a connector 22 may incorporate the improvements already discussed. In particular, the connector 22 can include a housing (e.g., plastic, composite material) 24 that includes an upstream channel 26 and a plurality of downstream channels 28 (28a-28c). The upstream channel 26 might be coupled to a circuit board that in turn facilitates connection to other system components such as a processor, chipset, etc. In the illustrated example, the downstream channels 28 are coupled to memory cards 30 (30a-30c). One or more of the downstream channels 28 could alternatively be coupled to termination cards (e.g., for unused slots), network cards, other IO devices, and so on. The connector 22 may also include a matching node 32 that couples power between the upstream channel 26 and the downstream channels 28. As already noted, the matching node 32 could include a power divider/combiner, microwave coupler, transformer based device, etc., configured to isolate the signals on the downstream channels 28 from one another, and match the impedance of the upstream channel 26 to the impedances of one or more of the downstream channels 28. Accordingly, the illustrated approach can achieve the above-described advantages with respect to improving bus performance, reducing interconnect length sensitivity, and making design processes more effective, via the connector 22.

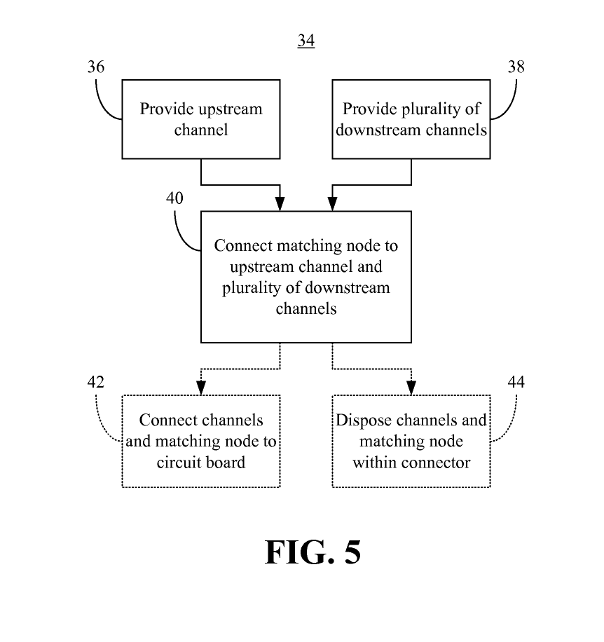

Turning now to FIG. 5, a method 34 of fabricating a memory bus is shown. The method 34 may be implemented using well documented semiconductor fabrication, hardware manufacturing, plastics injection molding, surface mount technology (SMT) solder reflow, bonding, assembly, trace layout design, and other techniques, or any combination thereof. Illustrated processing block 36 provides an upstream channel, and illustrated processing block 38 provides a downstream channel. The channels could include one or more lines (e.g., conductors, traces, vias, wires, etc.) capable of supporting the transfer of one or more signals. A matching node is connected to the upstream channel and the downstream channels at processing block 40, wherein the matching node may be configured to couple power between the upstream channel and the downstream channels, match the impedance of the upstream channel to the impedances of one or more of the downstream channels, and isolate two or more signals on the downstream channels from one another, as already discussed.

Processing block 42 connects the channels and the matching node to a circuit board such as circuit board 10 (FIG. 1), already discussed. Alternatively, processing block 44 connects the channels and the matching node to a connector such as connector 22 (FIG. 2), also already discussed. The order of conducting the illustrated processing blocks in method 34 may vary depending upon the circumstances. In addition, the channels could be memory or other input/output (IO) channels, wherein the matching node might include a power divider/combiner, microwave coupler, transformer based device, and so on.

Embodiments of the present invention are applicable for use with all types of semiconductor integrated circuit (“IC”) chips. Examples of these IC chips include but are not limited to processors, controllers, chipset components, programmable logic arrays (PLAs), memorys chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A method comprising:
providing an upstream memory channel;
providing a plurality of downstream memory channels, wherein the upstream memory channel and the plurality of downstream memory channels include at least one of an address line, a data line and a control line; and
connecting a matching node to the upstream memory channel and the plurality of downstream memory channels, wherein the matching node is to couple power between the upstream memory channel and the plurality of downstream channels, and wherein the matching node is to match an impedance of the upstream channel to one or more impedances of the plurality of downstream channels, wherein coupling the power between the upstream channel and the plurality of downstream channels includes isolating two or more signals on the plurality of downstream channels from one another.

2. The method of claim 1, wherein the matching node includes at least one of a power divider/combiner, a microwave coupler and a transformer based device.

3. The method of claim 1, further including connecting the upstream memory channel, the plurality downstream memory channels, and the matching node to a circuit board.

4. The method of claim 1, further including disposing the upstream memory channel, the plurality of downstream memory channels, and the matching node within a connector.

5. A circuit board comprising:
a substrate including an upstream channel and a plurality of downstream channels; and
a matching node to couple power between the upstream channel and the plurality of downstream channels.

6. The circuit board of claim 5, wherein the matching node is to isolate two or more signals on the plurality of downstream channels from one another.

7. The circuit board of claim 5, wherein the matching node is to match an impedance of the upstream channel to one or more impedances of the plurality of downstream channels.

8. The circuit board of claim 5, wherein the upstream channel and the plurality of downstream channels include one or more memory channels.

9. The circuit board of claim 8, wherein the one or more memory channels include at least one of an address line, a data line and a control line.

10. The circuit board of claim 5, wherein the upstream channel and the plurality of downstream channels include one or more input/output channels.

11. The circuit board of claim 5, wherein the matching node includes at least one of a power divider/combiner, a microwave coupler and a transformer based device.

12. The circuit board of claim 5, further including:
a first component coupled to the upstream channel, wherein the first component includes at least one of a processor and a chipset; and
a plurality of second components including a second component coupled to each of the plurality of downstream channels, wherein the plurality of second components includes at least one of a connector and a memory device.

13. A connector comprising:
a housing including an upstream channel and a plurality of downstream channels; and
a matching node to couple power between the upstream channel and the plurality of downstream channels.

14. The connector of claim 13, wherein the matching node is to isolate two or more signals on the plurality of downstream channels from one another.

15. The connector of claim 13, wherein the matching node is to match an impedance of the upstream channel to one or more impedances of the plurality of downstream channels.

16. The connector of claim 13, wherein the upstream channel and the plurality of downstream channels include one or more memory channels.

17. The connector of claim 16, wherein the one or more memory channels include at least one of an address line, a data line and a control line.

18. The connector of claim 16, further including a plurality of components including a component coupled to each of the plurality of downstream channels, wherein the plurality of components includes one or more memory cards.

19. The connector of claim 13, wherein the upstream channel and the plurality of downstream channels include one or more input/output channels.

20. The connector of claim 13, wherein the matching node includes at least one of a power divider/combiner, a microwave coupler and a transformer based device.

21. A memory card comprising:
a substrate including an upstream channel and a plurality of downstream channels;
a matching node to couple power between the upstream channel and the plurality of downstream channels; and
a plurality of memory chips including a memory chip coupled to each of the plurality of downstream channels.

22. The memory card of claim 21, wherein the matching node is to isolate two or more signals on the plurality of downstream channels from one another.

23. The memory card of claim 21, wherein the matching node is to match an impedance of the upstream channel to one or more impedances of the plurality of downstream channels.

24. The memory card of claim 21, wherein the upstream channel and the plurality of downstream channels include one or more memory channels having at least one of an address line, a data line and a control line.

25. The memory card of claim 21, wherein the matching node includes at least one of a power divider/combiner, a microwave coupler and a transformer based device.
